(19) United States
(12) Patent Application Publication
(10) Pub. No.: US 2026/0072324 A1
(43) Pub. Date: Mar. 12, 2026

(54) WEAK VALUE AMPLIFICATION DEVICES AND METHODS FOR MODULATION, ULTRAHIGH AMPLIFICATION, AND OPTICAL READOUT

(71) Applicant: University of Rochester, Rochester, NY (US)

(72) Inventors: Jaime Cardenas Gonzalez, Rochester, NY (US); Meiting Song, Rochester, NY (US)

(73) Assignee: University of Rochester, Rochester, NY (US)

(21) Appl. No.: 19/105,108

(22) PCT Filed: Aug. 21, 2023
(86) PCT No.: PCT/US2023/072534

§ 371 Date: Feb. 20, 2025

Related U.S. Application Data
(60) Provisional application No. 63/399,878, filed on Aug. 22, 2022.

(51) Int. Cl. G02F 1/225; G02F 1/21

(52) U.S. Cl. CPC G02F 1/225; G02F 1/212

(57) ABSTRACT

An inverse weak value amplification device for optical amplitude modulation includes a Mach-Zehnder interferometer (MZI) having an MZI input port and an MZI output port. The MZI includes a first arm and a second arm. A controlled phase shifter has a modulation input port and a phase shifter optical output, the controlled phase shifter disposed in the first arm. A first mode coupler is optically coupled to the phase shifter optical output of the controlled phase shifter in the first arm. A second mode coupler is disposed in the second arm. An inverse weak value amplification device for ultra-high amplification and a laser stabilization inverse weak value amplification device are also described.

### CROSS-REFERENCE TO RELATED APPLICATIONS

This application is a national stage application under 35 U.S.C. § 371 of PCT Application No. PCT/US2023/72534, filed Aug. 21, 2023, WEAK VALVE AMPLIFICATION DEVICE AND METHODS FOR MODULATION, ULTRAHIGH AMPLIFICATION, AND OPTICAL READOUT, published as WO 2024/04421, which claims priority to and the benefit of U.S. provisional patent application Ser. No. 63/399,878 WEAK VALVE AMPLIFICATION DEVICE AND METHODS FOR MODULATION, ULTRAHIGH AMPLIFICATION, AND OPTICAL READOUT, filed Aug. 22, 2022, the contents of which are incorporated herein by reference in its entirety.

### FIELD OF THE APPLICATION

The application relates to weak value amplification devices, particularly to integrated planar weak value amplification devices.

### BACKGROUND

In the background, other than the bolded paragraph numbers, non-bolded square brackets (“[ ]”) refer to the citations listed hereinbelow.

Optical modulation plays an important role in many fields [1] such as communications and metrology.

### SUMMARY

In one or more illustrative embodiments, an inverse weak value amplification device for optical amplitude modulation includes a Mach-Zehnder interferometer (MZI) having an MZI input port and an MZI output port. The MZI includes a first arm and a second arm. A controlled phase shifter has a modulation input port and a phase shifter optical output with the controlled phase shifter disposed in the first arm. A first mode coupler is optically coupled to the phase shifter optical output of the controlled phase shifter in the first arm. A second mode coupler is disposed in the second arm.

In embodiments, the inverse weak value amplification device may further include an additional controlled phase shifter optically coupled to and preceding the second mode coupler in the second arm.

In some embodiments, the controlled phase shifter may include a voltage controlled phase shifter. In illustrative embodiments, the voltage controlled phase shifter may include integrated electrodes.

In embodiments, the inverse weak value amplification device may further include an erbium-doped fiber amplifier (EDFA) optically coupled to the MZI output port to provide an amplified modulated light. In some embodiments, the inverse weak value amplification device may further include a semiconductor optical amplifier (SOA) optically coupled to the MZI output port to provide an amplified modulated light. In illustrative embodiments, the inverse weak value amplification device may further include an additional MZI output port to provide a recycle light. In embodiments, the inverse weak value amplification device may include an integrated inverse weak value amplification device with planar waveguides. In some embodiments, the integrated inverse weak value amplification device with a plurality of planar waveguides may include a length in a longitudinal direction of the first arm of less than about 100 μm. In illustrative embodiments, the integrated inverse weak value amplification device with a plurality of planar waveguides may include a length in a longitudinal direction of the first arm of less than about 2.5 mm.

In accordance with one illustrative embodiment, an inverse weak value amplification device for ultra-high amplification includes a Mach-Zehnder interferometer (MZI) having an MZI input port and an MZI output port with the MZI including a first arm and a second arm. A wavefront tilter is disposed in the first arm including a mode coupler. A tunable amplification section is disposed in the wavefront tilter preceding and optically coupled to the mode coupler.

In embodiments, the inverse weak value amplification device may further include a voltage controlled micro heater thermally coupled to the tunable amplification section. In some embodiments, the inverse weak value amplification device may further include a carrier injection or carrier depletion voltage control of the tunable amplification. In illustrative embodiments, the inverse weak value amplification device may further include an electro-optic effect voltage control of the tunable amplification. In embodiments, the inverse weak value amplification device may further include a multimode directional coupler optically coupled to the MZI output port.

In accordance with one or more illustrative embodiments, an inverse weak value amplification device for optical readout of a sensor includes a Mach-Zehnder interferometer (MZI) having an MZI input port and an MZI output port with the MZI including a first arm and a second arm. A first wavefront tilter is disposed in the first arm including a first mode coupler. A first tunable amplification section is disposed in the first wavefront tilter preceding and optically coupled to the first mode coupler. A second wavefront tilter is disposed in the second arm including a second mode coupler. A second tunable amplification section is disposed in the second wavefront tilter preceding and optically coupled to the second mode coupler. A mode sensitive coupler includes a mode sensitive coupler input port and at least one mode sensitive coupler output port. A reference mirror is optically coupled the second arm, and a sensor optical signal is optically coupled to the first arm. The at least one mode sensitive coupler output port provides the optical readout.

In embodiments, the mode sensitive coupler may be a multimode directional coupler (MMI). The mode sensitive coupler can be a Y-junction device.

In some embodiments, the inverse weak value amplification device for optical readout of a sensor may further include a voltage controlled micro heater thermally coupled to at least one of the first tunable amplification section or the second tunable amplification section. In illustrative embodiments, the inverse weak value amplification device for optical readout of a sensor may further include a carrier injection or carrier depletion voltage control of at least one of the first tunable amplification section or the second tunable amplification section. In embodiments, the inverse weak value amplification device for optical readout of a sensor may further include an electro-optic effect voltage control of at least one of the first tunable amplification section or the second tunable amplification section.

In accordance with one or more illustrative embodiments, a laser stabilization inverse weak value amplification device includes a Mach-Zehnder interferometer (MZI) having an MZI input port and an MZI output port with the MZI including a first arm and a second arm. A dispersive element is disposed in the first arm followed by a first wavefront tilter disposed in the first arm including a first mode coupler. A first tunable amplification section is disposed in the first wavefront tilter preceding and optically coupled to the first mode coupler. A second wavefront tilter is disposed in the second arm including a second mode coupler. A second tunable amplification section is disposed in the second wavefront tilter preceding and optically coupled to the second mode coupler. A multimode directional coupler including a first input port is optically coupled to an optical output of the first wavefront tilter, a second input port optically coupled to a second wavefront tilter optical output, an output port.

In accordance with one or more illustrative embodiments, a laser stabilization system which includes the laser stabilization inverse weak value amplification device described herein includes a laser and a modulator optically coupled to laser. The laser stabilization inverse weak value amplification device is optically coupled to the modulator. A balanced detector is optically coupled to the laser stabilization inverse weak value amplification device with the balanced detector having a balanced detector optical output. A PDH is electrically coupled to the balanced detector optical output. The PDH also includes a first PDH output and a second PDH output. The laser is electrically coupled to and receives the first PDH output, and the modulator is electrically coupled to and receives the second PDH output.

In embodiments, the dispersive element may include a ring resonator.

The foregoing and other aspects, features, and advantages of the application will become more apparent from the following description and from the claims.

### BRIEF DESCRIPTION OF THE DRAWINGS

The features of the application can be better understood with reference to the drawings described below, and the claims. The drawings are not necessarily to scale, emphasis instead generally being placed upon illustrating the principles described herein. In the drawings, like numerals are used to indicate like parts throughout the various views.

FIG. 1A is a drawing illustrating a schematic diagram of a Mach-Zehnder interferometer (MZI) with weak value amplification (WVA);

FIG. 1B is a drawing illustrating a graph of power vs. amplitude for the MZI of FIG. 1A;

FIG. 2 is a drawing illustrating schematic diagram of an exemplary optical amplitude modulator with inverse weak value amplification according to the Application;

FIG. 3A is a drawing illustrating a schematic diagram and corresponding graph of power vs. bandwidth where weak value amplification increases the signal without increasing the noise for a standard interferometer;

FIG. 3B is a drawing illustrating a schematic diagram and corresponding graph of power vs. bandwidth where weak value amplification increases the signal without increasing the noise whereby using quantum correlations (e.g., squeezed light) the noise floor can be lowered while the signal stays the same;

FIG. 3C is a drawing illustrating a schematic diagram and corresponding graph of power vs. bandwidth where in weak value amplification, the noise stays the same, but the signal is amplified leading to an increased signal to noise ratio without fragile quantum correlations;

FIG. 4 is a drawing illustrating a schematic diagram of an MZI with weak value amplification;

FIG. 5A is a drawing illustrating a mode coupler device that converts light from waveguide B into a higher order mode;

FIG. 5B is drawing illustrating a Multimode interference (MMI) component that measure the ratio of TE₀ to TE₁ to extract the phase;

FIG. 5C is a graph illustrating simulated power in waveguide of multimode directional coupler illustrating 50:50 coupling for both TE₀ and TE₁ modes;

FIG. 5D is a graph illustrating calculated output of MMI illustrating dependence of measured output power on TE₀ to TE₁ ratio;

FIG. 5E is a graph illustrating measured signals on a RF spectrum analyzer;

FIG. 6A is a drawing illustrating a graph of coupled power error for a same waveguide width;

FIG. 6B is a drawing illustrating a graph of coupled power error for a different waveguide width;

FIG. 7 is a drawing illustrating a schematic diagram of a tunable higher order mode coupler;

FIG. 8A is drawing illustrating a schematic diagram of an exemplary high ER IWVA MZI for very high amplification;

FIG. 8B is drawing illustrating a graph of a calculated extinction ratio by tuning the heater on a tunable coupler;

FIG. 9 is drawing illustrating a schematic diagram of a weak value amplified optical readout;

FIG. 10A is a drawing illustrating a schematic diagram of an exemplary WVA laser stabilization device where the dispersive element (ring resonator) converts laser frequency changes into phase; and

FIG. 10B is a graph illustrating frequency measurement using the IWVA MZI with ring resonator of FIG. 10A.

### DETAILED DESCRIPTION

In the description, other than the bolded paragraph numbers, non-bolded square brackets (“[ ]”) refer to the citations listed hereinbelow.

Several references are identified herein to assist in understanding the context in which the invention is made, some of the distinctions of the inventive structures and methods over that which was known prior to the invention, and advantages of this new invention, the entire contents of which being incorporated herein by reference. This list is intended to be illustrative rather than exhaustive.

All identified references are herein incorporated by reference to the same extent as if each publication or report, or patent or pending patent and/or references listed in these publications, reports, patents or pending patents were specifically and individually indicated to be incorporated by reference.

Unless otherwise stated, the term about is defined hereinbelow as a cited value +/−10% of the cited value.

This Application is in two parts. Part 1 describes an integrated photonic modulator with weak value amplification (WVA). Part 2 describes ultrahigh amplification WVA devices and optical readouts. Some elements, such as the tunable elements described in Part 2 may be suitable for use in structures of Part 1 and some elements, such as the tunable elements described in Part 1 may be suitable for use in the structures of Part 2.

Part 1—Integrated Photonic Modulator with Weak Value Amplification

Optical modulation plays an important role in many fields [1] such as communications and metrology. One method of integrated optical modulation can be performed by tuning the phase in an optical interferometer (ex. a Mach-Zehnder interferometer, MZI). By changing the phase on one arm of the integrated interferometer, the output power changes accordingly and achieves amplitude modulation (AM).

Weak value amplification allows for a more sensitive amplitude modulation to the phase change of the interferometer. Weak value amplification [2-4] amplifies the signal of an interferometric measurement without the cost of amplifying time-correlated noise, systematic noise, and other technical noises [5, 6]. Weak value amplification enhances phase shift signal through pre-selection, by slightly coupling to an orthogonal state, and post-selection, selecting a small subset of data [2, 7, 8]. Consider a quantum system prepared in an initial state |i [symbol] (pre-selection) and final state |f [symbol] (post-selection) with a Hermitian operator Â representing an observable quantity. In the absence of an interaction with Â, the probability of detection is given by P=| [symbol] f|i [symbol] |². A Hermitian operator A can generate a continuous transformation along a complementary parameter ϵ via the unitary operator Û(ϵ)=exp(−iϵÂ) (Stone's theorem [8]). For small ϵ it can be shown that the probability becomes P_{ϵ}=P+2ϵIm( [symbol] i|f [symbol] [symbol] f|Â|i [symbol] +O(ϵ²). The ratio to compare the detection probability with and without the unitary interaction is taken:

$$\frac{P}{{P}_{ϵ}} = 1 + 2 ϵIm \frac{〈 f \vert \hat{A} \vert i 〉}{〈 f \vert i 〉} + O ( {ϵ}^{2} )$$

where higher order terms of □ can be neglected when it is small. The coefficient

$${A}_{w} = \frac{〈 f \vert \hat{A} \vert i 〉}{〈 f \vert i 〉}$$

is called the weak value of Â and the ratio increases as |f [symbol] and |i [symbol] are closer to perfectly orthogonal without becoming orthogonal.

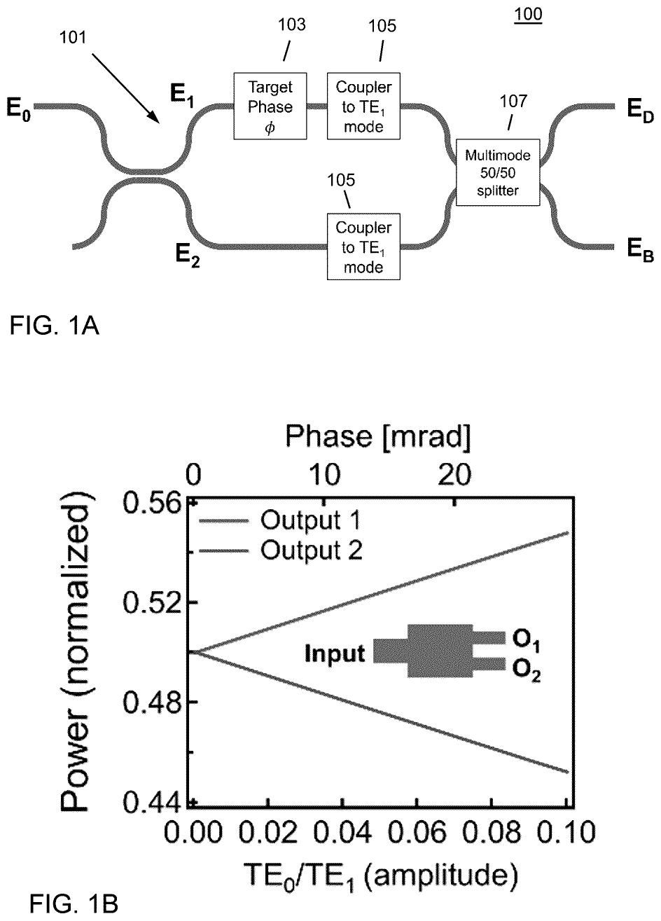

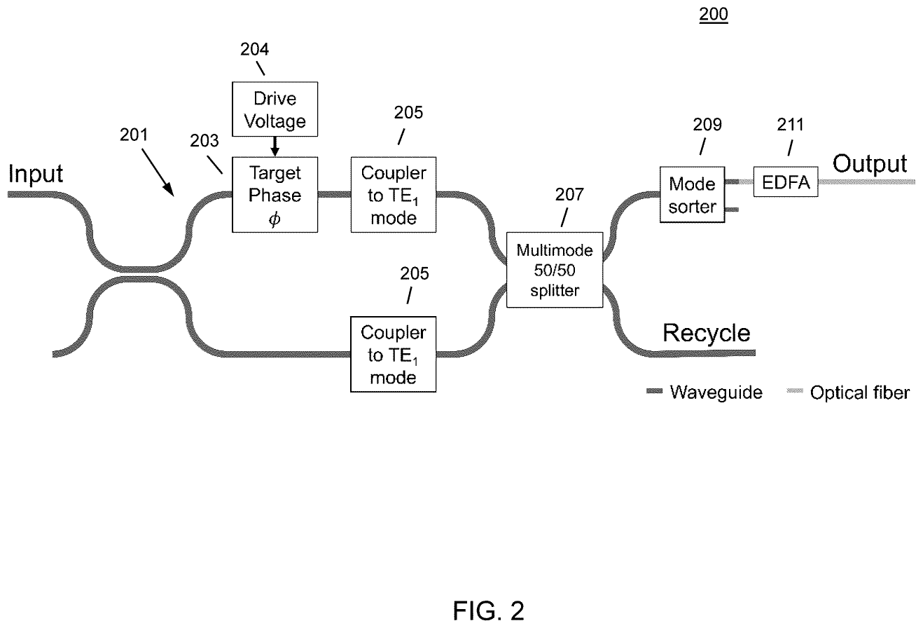

FIG. 1A is a drawing showing a schematic diagram of a Mach-Zehnder interferometer (MZI) with weak value amplification. The TE₁ mode couplers and multimode 50:50 splitter are components not found in standard MZIs. Exemplary integrated photonic modulator with weak value amplification (WVA) 100 works with a new topology of MZI 101. The optical input of the integrated photonic modulator with WVA 100 is input port E₀. The first arm of MZI 101, also referred to as the upper arm, includes a phase shifter 103. The modulator function is accomplished by providing a controlled phase shifter, such as, for example, the voltage controlled phase shifter of FIG. 2. Any suitable phase shifter can be used including, for example, a ring resonator or a dispersive element. In the first arm of MZI 101, following the phase shifter 103 is a mode coupler 105. In the exemplary integrated photonic modulator with WVA 100, the mode coupler 105 couples to the TE₁ mode. The second arm of MZI 101, also referred to as the lower arm, includes a mode coupler 105. Both outputs of the MZI 101 are optically coupled to a multimode 50/50 splitter 107, where output port ED can provide the modulated output light of integrated photonic modulator with WVA 100.

The weak value photonic MZI translates directly to the general quantum equations of weak values. The quantum description of weak value amplification can be extended directly to electromagnetic waves [9] and implemented in an integrated photonic device [10, 11]. Consider a Mach-Zehnder interferometer as shown schematically in FIG. 1. Light is input on the top left waveguide in the fundamental TE mode, TE₀. After the first 50:50 beam splitter the fields in the top and bottom waveguides, labeled 1 and 2, respectively, are.

$$\begin{matrix}{E}_{1} = \frac{1}{\sqrt{2}} T {E}_{0} ( x ) \\ {E}_{2} = \frac{1}{\sqrt{2}} T {E}_{0} ( x )\end{matrix}$$

A relative phase φ between the two arms is introduced to find:

$$\begin{matrix}{E}_{1} = \frac{{e}^{i \frac{ϕ}{2}}}{\sqrt{2}} T {E}_{0} ( x ) \\ {E}_{2} = \frac{{e}^{- i \frac{ϕ}{2}}}{\sqrt{2}} T {E}_{0} ( x )\end{matrix}$$

The pre-selected state is created by coupling a small fraction, a₁, of the TE₀ mode to the TE₁ mode. a₁ is small.

$$\begin{matrix}{E}_{1} = \frac{{e}^{i \frac{ϕ}{2}}}{\sqrt{2}} [ {a}_{0} {TE}_{0} ( x ) + {ia}_{1} {TE}_{1} ( x ) ] \\ {E}_{2} = \frac{{e}^{- i \frac{ϕ}{2}}}{\sqrt{2}} [ {a}_{0} {TE}_{0} ( x ) - {ia}_{1} {TE}_{1} ( x ) ] , \\ where {a}_{0}^{2} + {a}_{1}^{2} = 1\end{matrix}$$

assuming lossless coupling between modes.

The dark port the electric field simplifies to

$${E}_{d} = {E}_{1} - {E}_{2} \approx i [ {a}_{0} \frac{ϕ}{2} {TE}_{0} ( x ) + {a}_{1} {TE}_{1} ( x ) ] = {ia}_{1} [ {TE}_{1} ( x ) + \frac{{a}_{0}}{{a}_{1}} \frac{ϕ}{2} {TE}_{0} ( x ) ] .$$

FIG. 1B is a drawing showing a graph of power vs. amplitude for the MZI of FIG. 1A. By comparing this expression with the general weak value amplification expression, it is seen that the weak value is

$$\frac{{a}_{0}}{{a}_{1}}$$

and the phase φ is equivalent to ϵ (to within a multiplicative factor of 4). Then the dark port signal is sent through an MMI (multimode interfering region) to determine the ratio between the TE₀ and TE₁ mode, which corresponds to the phase shift φ as shown in FIG. 1B.

Inverse weak value amplification (IWVA) is the term used when using weak values to measure the phase. With weak values, both the phase and the weak value must be much smaller than 1. The phase of the interferometer is used to amplify the weak value or the weak value is used to amplify the phase. The distinction in a particular system depends on which quantity is much larger than the other. If the weak value is much weaker than the phase, it is called Weak Value Amplification. If the phase is much weaker than the weak value, it is called Inverse Weak Value Amplification. Moreover, weak value amplification (WVA) consists in measuring the spatial phase front tilt, using the known phase shift to amplify the signal. Inverse weak value amplification (TWVA) consists in measuring the phase shift with the signal amplified by the known spatial phase front tilt. In the WVA regime, the measured parameter, phase front tilt, is smaller than the propagation phase shift. In the IWVA regime, the propagation phase shift is smaller than the phase front tilt, which is opposite from WVA. The two operating regimes allow different applications of weak value techniques. In a waveguide interferometer, phase shift is commonly used for sensing purposes as other sensing parameters, such as temperature and features of bio samples, can be easily converted to phase shifts applied to the waveguide. For optical interferometry, we are usually interested in the phase and thus, use inverse weak value amplification.

FIG. 2 is a drawings showing schematic diagram of an exemplary optical amplitude modulator with inverse weak value amplification according to the Application. The input port provides the optical input of the integrated photonic modulator with WVA 200. Similar to the exemplary integrated photonic modulator with WVA 100 of FIG. 1A the first arm of MZI 201 includes a voltage controlled phase shifter 203. The modulator function is accomplished by providing a modulating drive voltage 204 to the voltage controlled phase shifter. Any suitable controlled phase shifter can be used. For example, voltage controlled phase shifter 203, labeled target phase block can operate by applying the modulating drive voltage 204 to integrated electrode pads of the voltage controlled phase shifter 203 to control the phase delay. In the first arm of MZI 201, following the voltage controlled phase shifter 203 is a mode coupler 205. In the exemplary integrated photonic modulator with WVA 200, the mode coupler 203 couples to the TE₁ mode. The second arm of MZI 201, also referred to as the lower arm, includes a mode coupler 205. Both outputs of the MZI 201 are optically coupled to a multimode 50/50 splitter 207, where ED can provide the modulated output light of integrated photonic modulator with WVA 200. Following a mode sorter 209 of the first output of MZI 201 there can be, for example, an erbium-doped fiber amplifier (EDFA) 211 to provide an amplified modulated output light of the integrated photonic modulator with WVA 200. Any suitable optical amplifier can be used, such as, for example, a semiconductor optical amplifier (SOA). The second output of MZI 201 can be used to provide a recycled light. Waveguide of FIG. 2 refers to integrated, typically planar waveguides where Optical fiber refers to a discrete optical fiber which typically leaves the photonic integrated circuit, here as an optical output fiber.

It is unimportant whether the controlled phase shifter is located in the first or second arm of the MZI. Moreover, there can be a phase shifter in both arms.

It is realized that the integrated inverse weak value amplification device can be used for optical amplitude modulation. The output optical power of the weak value device is proportional to small phase signals. Therefore, the output power can be modulated by the applied phase signal. With the same applied phase signal and detected optical power, the weak value device has a larger power change, i.e., a larger response, compared to a regular MZI modulator working at quadrature (largest response). Therefore, the weak value modulator can be driven at a smaller voltage than a regular MZI modulator. An EDFA (erbium-doped fiber amplifier), for example, could be used to boost the output power for subsequent transmission as the post selection lowers the total power output in the dark port, as shown in FIG. 2.

The modulation depth can be tuned by the coupler to TE₁ mode. The response of the modulation depends on the amplification factor of the weak value device. The amplification factor can be determined by the initial coupling ratio to the TE₁ mode, which is controlled by the coupler to TE₁ mode. By having a smaller coupling ratio to TE₁ mode (a₁), the amplification factor (a₀/a₁) is increased. Therefore, the modulation amplitude is changed for the same drive voltage and phase signal φ.

The weak value modulator can also be more compact than a regular MZI modulator. In order to accumulate π phase shift and achieve full extinction modulation, regular MZI modulators are generally several millimeters long. Because the weak value device is more sensitive to phase shifts, the interferometric arm length can be shorter therefore the device could be smaller. The total length of the weak value modulator could be, much shorter, for example, less than 100 μm to more typically less than 1 mm to 2 mm. For example, an integrated inverse weak value amplification device with planar waveguides can have a length in a longitudinal direction of the first arm of less than about 2.5 mm.

The bright port output light can be recycled into the same modulator device or to another modulator. For example, the bright port light can be recycled back into the device to further increase the response of a weak value device [12]. Or the bright port light can be sent to power another modulator after removing the TE₁ mode, which contains the phase shift information.

### Part 2—Ultrahigh Amplification WVA Devices and Optical Readouts

Optical interferometry plays a critical role in precision metrology of gravitational wave detection [1, 2], navigation [3-5], position and motion, and environmental sensing. For example, the need for sub-nm displacement sensors is critical for stage control and alignment in the semiconductor industry as it goes to single nanometer resolution. As more compact vehicles, such as drones, become ubiquitous, high sensitivity navigation using compact optical gyroscopes will become crucial. The classical limit for sensitivity is the standard quantum limit, due to the quantum nature of photons and is usually dominated by shot noise in interferometers. In practice, it is challenging to reach shot noise limited operation for most interferometric sensors. Weak value amplification [6-8] amplifies the signal of an interferometric measurement without the cost of amplifying time correlated noise, systematic noise, and other technical noises [9, 10]. However, to date, previous demonstrations of weak value amplification required complex laboratory setups with exquisite alignment and were vulnerable to environmental changes.

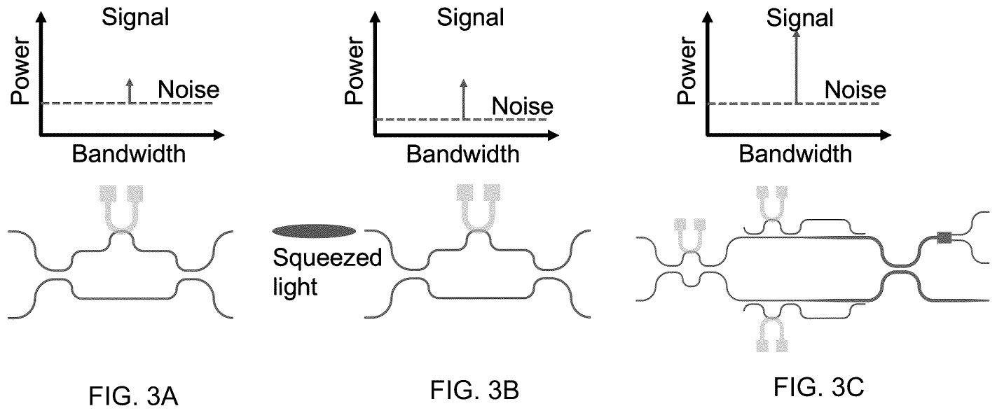

FIG. 3A is a drawing showing a schematic diagram and corresponding graph of power vs. bandwidth where weak value amplification increases the signal without increasing the noise for a standard interferometer. FIG. 3B is a drawing showing a schematic diagram and corresponding graph of power vs. bandwidth where weak value amplification increases the signal without increasing the noise where by using quantum correlations (e.g., squeezed light) the noise floor can be lowered while the signal stays the same. FIG. 3C is a drawing showing a schematic diagram and corresponding graph of power vs. bandwidth where in weak value amplification, the noise stays the same, but the signal is amplified leading to an increased signal to noise ratio without fragile quantum correlations.

Weak value amplification can amplify the signal without increasing the detected optical power. Weak value amplification allows systems to increase the signal to noise ratio (SNR) and achieve shot noise limited sensitivity. WVA works differently than using quantum correlations to increase the SNR. A standard shot noise limited interferometer will have a certain signal level and noise floor. Injecting squeezed light into the open port can decrease the noise floor by the level of squeezing. In weak value amplification, instead of lowering the noise floor, the signal is amplified while the noise floor stays unchanged compared to the standard interferometer (FIG. 3A to FIG. 3B). The result is an increased signal to noise ratio. The increase is equal to the level of weak value amplification given that we compare equal detected optical powers. This means the WVA interferometer needs a higher input power than a standard interferometer.

Weak value amplification enhances measurements through pre-selection, slightly coupling to an orthogonal state, and post-selection, selecting a small subset of data, [6, 54, 55]. The origin of weak value amplification (WVA) is quantum mechanical [6]. Consider a quantum system prepared in an initial state |i [symbol] (pre-selection) and final state |f [symbol] (post-selection) with a Hermitian operator Â representing an observable quantity. In the absence of an interaction with Â, the probability of detection is given by P=| [symbol] f|i [symbol] |². A Hermitian operator A can generate a continuous transformation along a complementary parameter ϵ via the unitary operator Û(ϵ)=exp(−iϵÂ) (Stone's theorem [55]). For small ϵ it can be shown that the probability becomes Pₑ=P+2ϵIm( [symbol] i|f [symbol] [symbol] f|Â|i [symbol] +O(ϵ²). The ratio is taken to compare the detection probability with and without the unitary interaction:

$$\frac{P}{{P}_{ϵ}} = 1 + 2 ϵ Im \frac{〈 f \vert \hat{A} \vert i 〉}{〈 f \vert i 〉} + O ( {ϵ}^{2} )$$

where higher order terms of E can be neglected when it is small. The coefficient

$${A}_{w} = \frac{〈 f \vert \hat{A} \vert i 〉}{〈 f \vert i 〉}$$

is called the weak value of Â and the ratio increases as |f [symbol] and |i [symbol] are closer to perfectly orthogonal without becoming orthogonal.

### On-Chip Weak Value Amplification

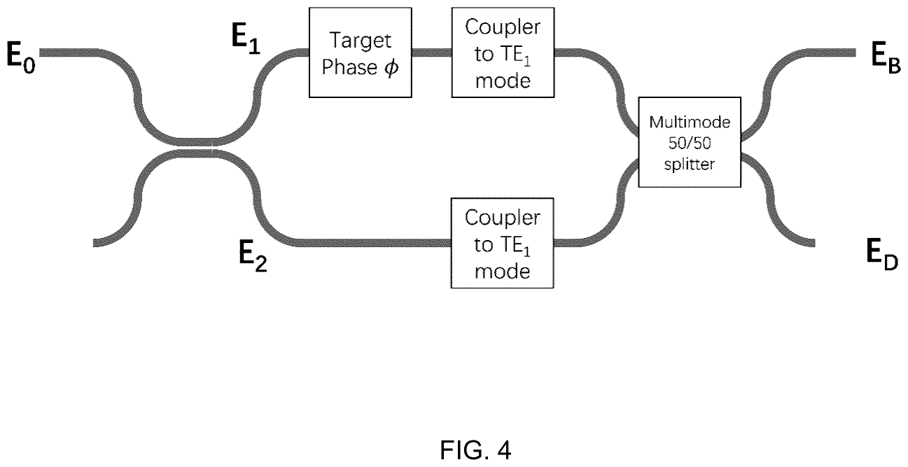

FIG. 4 is a drawing showing a schematic diagram of an MZI with weak value amplification. The TE₁ mode couplers and multimode 50:50 splitter are components not found in standard MZIs. The weak value photonic MZI translates directly to the general quantum equations of weak values. The quantum description of weak value amplification can be extended directly to electromagnetic waves [56] and implemented in an integrated photonic device [11 12]. Consider a Mach-Zehnder interferometer as shown schematically in FIG. 4. Light is input on the top left waveguide in the fundamental TE mode, TE₀. After the first 50:50 beam splitter the fields in the top and bottom waveguides, labeled 1 and 2, respectively, are.

$$\begin{matrix}{E}_{1} = \frac{1}{\sqrt{2}} T {E}_{0} ( x ) \\ {E}_{2} = \frac{1}{\sqrt{2}} T {E}_{0} ( x )\end{matrix}$$

A relative phase φ between the two arms is introduced to find:

$$\begin{matrix}{E}_{1} = \frac{{e}^{i \frac{ϕ}{2}}}{\sqrt{2}} T {E}_{0} ( x ) \\ {E}_{2} = \frac{{e}^{- i \frac{ϕ}{2}}}{\sqrt{2}} T {E}_{0} ( x )\end{matrix}$$

The pre-selected state is created by coupling a small fraction, a₁, of the TE₀ mode to the TE₁ mode. a₁ is small.

$$\begin{matrix}{E}_{1} = \frac{{e}^{i \frac{ϕ}{2}}}{\sqrt{2}} [ {a}_{0} {TE}_{0} ( x ) + {ia}_{1} {TE}_{1} ( x ) ] \\ {E}_{2} = \frac{{e}^{- i \frac{ϕ}{2}}}{\sqrt{2}} [ {a}_{0} {TE}_{0} ( x ) - {ia}_{1} {TE}_{1} ( x ) ] , \\ where {a}_{0}^{2} + {a}_{1}^{2} = 1\end{matrix}$$

assuming lossless coupling between modes.

One can show that at the detector the electric field simplifies to

$${E}_{d} \approx i [ {a}_{0} \frac{ϕ}{2} {TE}_{0} ( x ) + {a}_{1} {TE}_{1} ( x ) ] = {ia}_{1} [ {TE}_{1} ( x ) + \frac{{a}_{0}}{{a}_{1}} \frac{ϕ}{2} {TE}_{0} ( x ) ] .$$

By comparing this expression with the general weak value amplification expression, it is seen that the weak value is

$$\frac{{a}_{0}}{{a}_{1}}$$

and the phase φ is equivalent to ϵ (to within a multiplicative factor of 4).

Inverse weak value amplification (IWVA) is the term used when using weak values to measure the phase. With weak values, both the phase and the weak value must be much smaller than 1. The phase of the interferometer is used to amplify the weak value or the weak value to amplify the phase is used. The distinction in a particular system depends on which quantity is much larger than the other. If the weak value is much weaker than the phase, it is called Weak Value Amplification. If the phase is much weaker than the weak value, it is called Inverse Weak Value Amplification. For optical interferometry, we are usually interested in the phase and thus, use inverse weak value amplification.

### Standard MZI Vs Inverse Weak Value MZI

The response of the Inverse Weak Value MZI is larger than for a standard MZI. In a standard MZI, the phase information is encoded in the amplitude of the output. In the small angle approximation, i.e. for small phases, the change in output power is equal to the change in phase and is given by ΔI_{MZI}=φ. For the MZI with weak value amplification, the response in the small angle approximation is given by the ratio of the TE₀ and TE₁ modes in the dark port,

$$r = \frac{{a}_{0}}{{a}_{1}} \frac{ϕ}{2} .$$

The response of the inverse weak value MZI is inversely proportional to a₁, which is much smaller than a₀. Thus, the ratio

$$\frac{{a}_{0}}{{a}_{1}}$$

is much larger than 1.

The IWVA MZI produces a larger SNR when compared to a standard MZI with equal detected optical power [9, 11]. The IWVA amplifies both the signal and the shot noise maintaining shot noise limited SNR. However, the SNR is now achieved with a much lower optical power at the detectors. Since detectors have a saturation point and SNR goes up with the square root of optical power, the IWVA produces a higher SNR when the optical power is increased to match that of a standard MZI. To increase the amplification, a₁ can be decreased at the expense of a lower optical power at the dark port. The output power is lower for stronger amplification and increased SNR.

Measuring the TE₀ to TE₁ Ratio

To extract the phase from the weak value device the ratio of the power in the TE₀ and TE₁ modes is measured. A multimode interferometer (MMI) can be used to measure this ratio because of its compactness. The power in the outputs of the MMI is linearly dependent on the ratio between the TE₀ and TE₁ modes. As the phase signal of the weak value device increases, the amount of TE₀ light in the dark port increases and the difference in power between the MMI outputs also increases. For the preliminary results, the calculated difference in the MMI outputs is ΔI_{wv}=0.96 r, where r is the amplitude ratio between the TE₀ and TE₁ modes. It follows that ΔI_{wv}=3.36 φ, which yields an amplification factor of 3.36 (i.e., 10 dB after optical power is converted to electrical power) since a standard MZI goes as ΔI_{MZI}=φ.

Weak value amplification has been used to demonstrate measurements of optical beam displacements of a few femtometers [8] and object velocities as low as 400 fm/s [57]. However, these demonstrations were shown on large tabletop experiments, limiting the applications of this revolutionizing technique. By miniaturizing weak value amplification devices, weak value amplification devices can be used in ultrasensitive metrology applications for positioning, tracking, and sensing. Chip scale devices that exploit weak value amplification can transform the metrology landscape.

Weak value amplification can be implemented on a CMOS compatible integrated photonic platform that is naturally robust to misalignment. The weak value amplification on-chip interferometer can be based on our preliminary results with a Mach-Zehnder interferometer (MZI) [11, 12]. To implement the inverse weak value technique, a high order mode coupler is added, which serves the function of the wavefront tilt in the traditional free-space implementations (e.g., see [8]). The mode couplers carry out the preselection for weak value amplification. The second directional coupler of the MZI can be replaced, typically a 50:50 beam splitter for the fundamental mode, by a coupler that splits both modes 50:50.

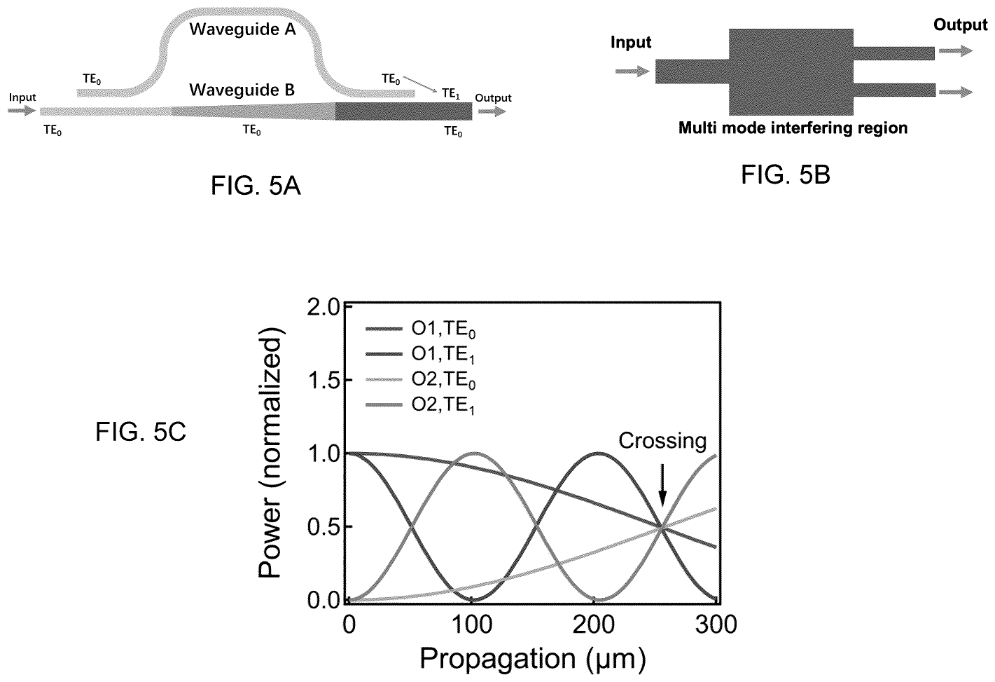

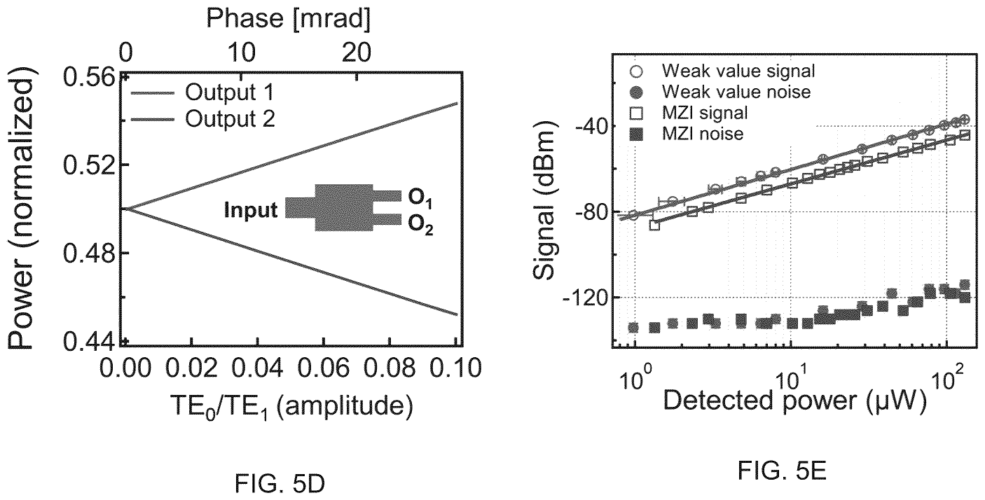

On-chip IWVA components and results. FIG. 5A is a drawing showing a mode coupler device that takes light from waveguide B and converts into a higher order mode. Waveguide A is a single mode waveguide that takes the fraction of light we want to convert from Waveguide B and then puts it back into the higher order mode of Waveguide B once Waveguide B has tapered to a multimode waveguide. The mode coupler device of FIG. 5A is called a wavefront tilter in reference to free space IWVA.

FIG. 5B is drawing showing a Multimode interference (MMI) component that measure the ratio of TE₀ to TE₁ to extract the phase. FIG. 5C is a graph showing simulated power in waveguide of multimode directional coupler showing 50:50 coupling for both TE₀ and TE₁ modes. FIG. 5D is a graph showing calculated output of MMI showing dependence of measured output power on TE₀ to TE₁ ratio. FIG. 5E is a graph showing measured signals on an RF spectrum analyzer showing the increased signal of the IWVA device with respect to standard interferometer. The noise for both devices is the same. IWVA does not increase noise and provides an increased signal when comparing equal powers at the detector.

In our preliminary implementation [11], the high order mode conversion is accomplished by coupling a small portion of the TE₀ light from a single mode waveguide into a second waveguide, then tapering the original waveguide to a width that supports TE₀ and TE₁ modes where the TE₁ mode is phase matched to the original TE₀ mode, and finally coupling the light from the second waveguide to the TE₁ mode of the tapered waveguide as shown in FIG. 5A.

Coupling structures can range from about 10 nm to 5 mm in length and waveguide widths can range from about 50 nm to 100 μm, more typically waveguide widths of about 10 μm or less, can be set to provide the high order directional coupler. The evanescent tail of the TE₁ mode extends much further than the one of the TE₀ mode. Thus, the TE₁ mode can couple more strongly. The waveguide width coupling length range can be set so that the TE₁ mode coupling can undergo a one and a quarter cycle while the TE₀ mode undergoes only a quarter cycle as shown in FIG. 5C. At this point, the directional coupler operates as a 50:50 beam splitter for both modes. The final element is a component that lets us measure the ratio of TE₁ to TE₀ in the dark port of the interferometer.

A multimode interferometer (MMI), for example, a multimode interference coupler, with a multimode input waveguide and two single mode output waveguides can have outputs that are dependent on the ratio between the TE₀ and TE₁ modes at the input as shown in FIG. 5B. When the input intensity distribution is symmetric, (i.e., for a pure TE₀ or TE₁ input) the output of the two waveguides is equal. However, when the input is a combination of TE₀ and TE₁, the output of the two waveguides is different. Our preliminary calculations show a linear relationship between the output of the two waveguides and input TE₀ to TE₁ ratio. As shown earlier, this ratio depends on the phase desired to measure in the interferometer as shown in FIG. 5D.

Our preliminary inverse weak value MZI shows an increase in signal power of 7 dB and a sensitivity enhancement factor of 2.2 compared to a standard MZI fabricated in the same platform. The phase changes were driven by integrated heaters on the standard MZI and the IWVA MZI. An exemplary device was designed for an SNR amplification of 10 dB. The IWVA MZI exhibits an increased signal for equal detected optical power (FIG. 5E) and has the same noise floor. Note that due to the weak value amplification, the input laser power in the IWVA MZI is higher than for the standard MZI so that their detected optical powers are equal.

Because the noise does not increase, the signal to noise ratio (SNR) increased by 7 dB. This increase compares favorably with previously demonstrated levels of on-chip squeezing (calculated ˜4 to 8 dB) [21, 58, 59] and record levels of observed squeezing (15 dB) [60]. Squeezing improves SNR by reducing the noise level by the squeezing amount. The enhancement due to weak value amplification instead increases the SNR by increasing the signal without adding noise. The maximum observed SNR enhancement using WVA is approximately 20 dB [8], but the limits are yet to be explored.

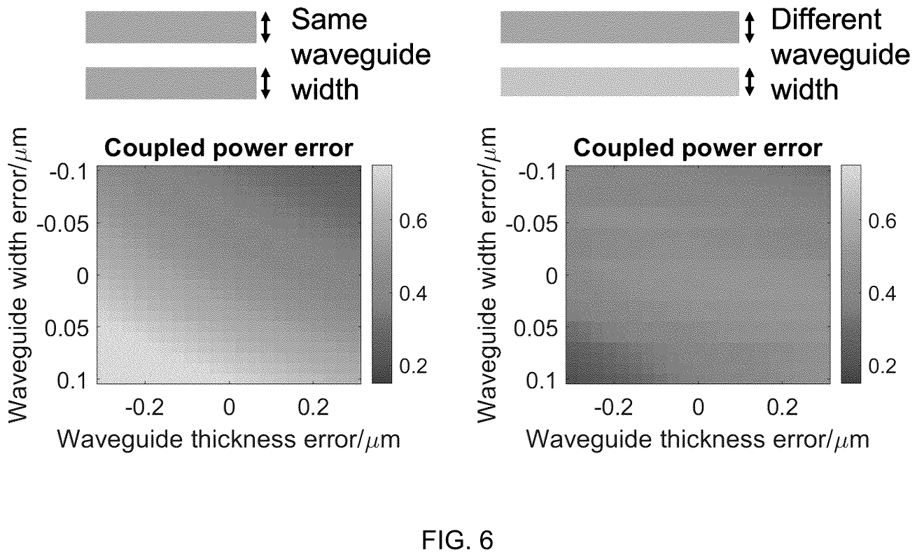

FIG. 6A is a drawing showing a graph of coupled power error for a same waveguide width. FIG. 6B is a drawing showing a graph of coupled power error for a different waveguide width. Coupling sensitivity as a function of errors in waveguide height and width for (FIG. 6A) phase matched waveguides and (FIG. 6B) phase mismatched waveguides proposed here. The phase mismatched waveguides can be less sensitive to errors in the waveguide geometry with a higher extinction ratio MZI.

The performance of on-chip weak value amplification can be maximized by a high extinction ratio multimode directional couplers, tunable higher order mode coupling, and investigating the signal dependence on the higher order mode(s) used.

Theoretically, by making the higher mode coupling weaker, the amplification factor increases without an upper bound. However, this assumes a post-selection (e.g., directional coupler or beam splitter) extinction ratio of infinity. For the system to stay in the weak value regime, the amplification factor should be much larger than the extinction ratio of the directional coupler doing the post-selection. In practice, the extinction ratio of the multimode directional coupler can be limited by the relative power in each mode on the two waveguides, which is never exactly equal. The geometry of the directional coupler can attain extinction ratios greater than 40 dB. This level of extinction ratio is achievable in foundry processes for single mode waveguides. Our approach to achieve higher extinction ratios is to modify the geometry of the waveguides by varying their widths and intentionally phase mismatching them. Our simulations show that for a waveguide coupler with a cross-section of 0.3 μm by 2.5 μm with a gap of 0.5 μm the coupling is much more sensitive than if one of the two waveguides in the coupler has a width of 2.415 μm. Note that the symmetric coupler is shorter, 235 μm vs 456 μm as shown in FIG. 6A and FIG. 6B. The phase mismatch has a broader bandwidth coupling that is less sensitive to the width and height of the waveguides. The phase mismatch can provide amplification factors on the order of 30 dB, which surpasses other sensing enhancement techniques previously demonstrated. Because the output power of the IWVA MZI depends on the amplification factor planned to introduce tunable weak value amplification.

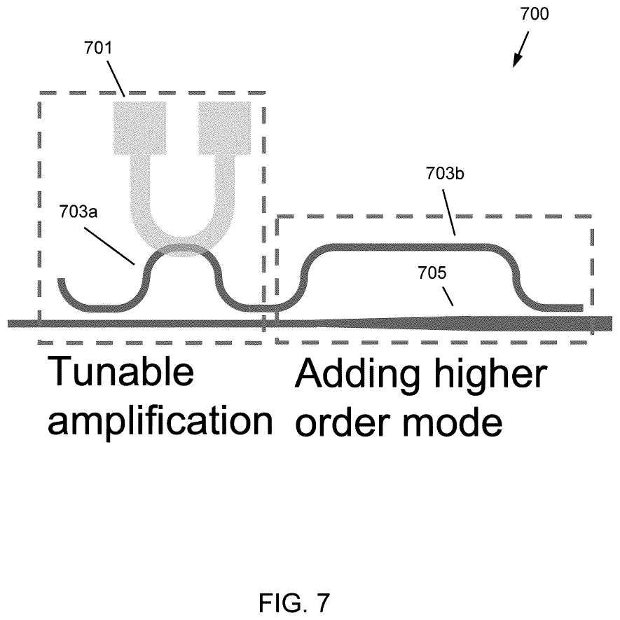

FIG. 7 is a drawing showing a schematic diagram of a tunable higher order mode coupler. The waveguide including first waveguide section 703a and second waveguide section 703b is optically coupled to a first arm 705 of a MZI (e.g., a Waveguide B of FIG. 5A). It is realized that a tunable amplification section 700 which includes the first waveguide section 703a and a micro heater 701 can be added. This new tunable amplification section 700 is important for ultra-high amplification. Ultra-high amplification uses high precision in device performance, which can be difficult to achieve in fabrication. The new tunable component (tunable amplification section 700) allows for compensation for fabrication errors or environmental changes. Both the tunable component in the mode coupler and in the first 50/50 splitter (tunable directional coupler) can be used for such compensation.

Any suitable control element can be used, typically a voltage control element. For example, there can be control by carrier injection or carrier depletion, such as in silicon structures. Or there can be control by the electro-optic effect, such as, for example, in lithium niobate. The index can also be controlled with 2D materials.

By controlling the heater voltage of micro-heater 701 of the new tunable amplification section 700, we can now tune the amount of light converted to a higher order mode. The tunable mode coupler can be used to tune the amplification factor of the device. As shown in FIG. 7, the strength of the coupling can be tuned and the level of amplification varied by introducing a tunable directional coupler in the high order mode coupler input side. Because the limited resource in many sensing modalities is the maximum detectable power due to detector saturation, the tunable amplification can allow for use of a fixed power laser and then tuning the amplification to always maintain the detector right below saturation for optimum SNR.

There can be an optimum mode and/or mode combination to maximize the signal power at the output of the IWVA MZI. Our preliminary demonstration has already shown great promise for signal enhancement by using the fundamental and first order modes. However, the mode coupling configuration can be used to generate a mode combination that includes higher order modes (e.g., second or third order) or combinations of them. The goal is to maximize the slope of the MMI output as a function of mode ratio or phase change (e.g., FIG. 5D). This area can be modelled numerically, then implemented experimentally using TE₀ and TE₁ modes. Limits of amplification

Previous demonstrations of weak value amplification with bulk optics have not pushed the limits of enhancement. The reported amplification factors are typically between 10 and 100. It is believed that the limits of amplification can achieve levels of 50 to 60 dB (i.e., 100,000 to 1,000,000). To limit the effects of the output power reduction on the dark port, optical amplification together with weak value amplification can be used, for the first time (to the best of our knowledge,) to recover up to 50 dB of the power drop while only paying approximately 4 dB in noise penalty. The effect of optical amplification on weak value measurements has not been shown before.

Optically amplified IWVA can provide a phase sensitivity comparable to that used by the LIGO (Laser Interferometer Gravitational-Wave Observatory) project, on a photonic chip. On-chip weak value interferometers with amplification factors starting at 40 dB and higher can be used to study the limits of amplification, such as, by reducing the higher order mode coupling coefficients. For example, for 40 dB of amplification, a coupling coefficient of 0.0001 ( 1/10,000) can be used, which is readily attainable in integrated photonics. This level of amplification is very challenging with bulk optics systems because the amplification factor for phase measurements is set by the misalignment of a mirror, which has practical limitations due to positioning accuracy and stability. Since the IWVA interferometer operates in the dark port, where very little light is available, high amplification factors lead to weak optical signals arriving at the detector. Weak value amplification surpasses other methods of sensing when considering equal power arriving at the detector, i.e., when the reduction in output power due to the amplification can be overcome [9, 11]. In these cases, the limited resource is the detector current. While SNR can be improved by increasing the optical power at the detector, SNR can only be increased up to the point where the detector saturates. Modern high current detectors can handle several tens of milliwatts of power before saturation. For very high amplification factors, increasing the laser power is not feasible. In our approach, a low noise erbium doped fiber amplifier (EDFA) can be used to recover 50 dB of optical power (typical gain of commercial EDFA pre-amplifiers). The EDFA introduces a noise figure of approximately 3.5 to 4.5 dB and our calculations show that the effect in the weak value amplification is a one for one reduction in amplification, i.e., the weak value enhancement in SNR can go down by the noise figure of the EDFA. The trade-off for 50 dB gain in optical power is a few dB in SNR. We can balance the input laser power with the EDFA gain to saturate a high current detector and explore the limits of weak value amplification. In our work, we show a phase sensitivity of 632 nanoradians/Hz^{1/2} with a weak value amplification of 7 dB. By reaching 60 dB of weak value amplification (−56 dB net after subtraction of EDFA noise figure), we can improve the sensitivity by almost three orders of magnitude (˜630×) to 2.2 nanoradians/Hz^{1/2}(49 dB better than our previous demonstration). An increase in detected power from the 0.5 mW used in our previous results, to 12.5 mW would improve sensitivity by another 5× down to 0.44 nanoradians/Hz^{1/2}. Detectors capable of handling 12.5 mW and higher are commercially available. This level of sensitivity approaches that of sophisticated, large scale instruments such as LIGO [61], on a robust, chip scale platform.

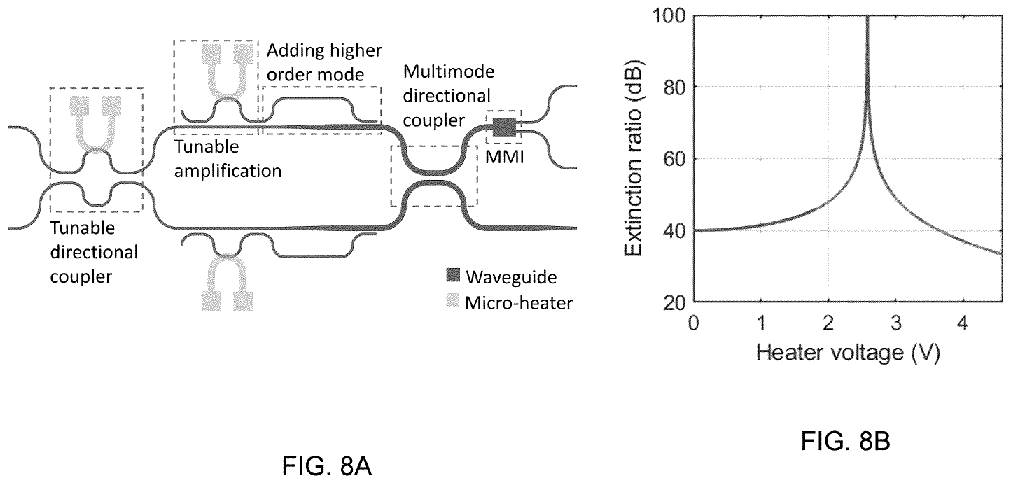

FIG. 8A is drawing showing a schematic diagram of an exemplary High ER IWVA MZI for very high amplification. By tuning the coupling, high extinction ratio interference with amplification factors of up to 60 dB can be achieved. FIG. 8B is drawing showing a graph of a calculated extinction ratio by tuning the heater (150 μm long, 3 μm wide microheater 3 μm above the waveguide) on the tunable coupler.

To successfully reach very high levels of amplification the optical power in the two arms of the IWVA MZI and in all spatial modes should be balanced to achieve full interference. The extinction ratio of the interferometer should be much larger than the amplification factor. A factor of ten is usually sufficient to meet this condition. This challenge can be overcome in two ways: by tuning the first MZI directional coupler and the higher order mode couplers; and by developing a tunable high order directional coupler for the interferometer. The tunable directional coupler for the initial splitter of the MZI includes a second Mach-Zehnder interferometer where all the waveguides are single mode. This tunable coupler allows us to unbalance the power in the arms of the MZI to account for differences in loss or coupling. As shown in FIG. 8A and FIG. 8B, a tunable coupler gives us a tuning knob to control the extinction of the fundamental modes when they interfere at the second splitter of the MZI.

Using the MZI's in the input part of the higher order mode coupler can be used to tune the amount of power coupled into the higher order mode. The coupling can be asymmetric by adjusting the coupler on each arm of the MZI to account for loss or coupling imbalance for the higher order mode in the second MZI splitter. The second approach introduces a tunable coupler only to the multimode coupler of the MZI, i.e., the second splitter. A tunable MZI can be used in place of the coupler. This MZI should simultaneously support the fundamental and higher order mode. A mode selective phase shifter in the tunable coupler arm can be used to ensure the two modes interfere in phase.

Increased amplification allows us to study the effects of the weak value device on other sources of noise, and whether any of these noises can place an upper bound on the weak value amplification. Weak value amplification mitigates noise sources that have temporal correlations such as colored noise or turbulence [10]. Weak value amplification also reduces the effects of systematic noise as well as technical noise sources. However, white noise, such as shot noise or laser relative intensity noise (RIN), propagate through the IWVA. We have shown that even when white noise propagates through the weak value device, a weak value device still gives a significant advantage when considering detection saturation. To increase the SNR of a measurement, the optical power can be increased. This signal increases with P, while the fundamental shot noise increases by P^{1/2}. Thus, the SNR fundamentally increases as P^{1/2}. However, one cannot continue to increase the detected power because the detector will saturate. To reach the highest possible SNR one would try to operate very close to the saturation of the detector, making the detector saturation power the limited resource in the measurement. The IWVA interferometer can maintain the SNR, but with a reduced optical power output by concentrating the photons that contain the information we want to measure into the dark port of the interferometer. Thus, we can continue to increase the SNR by increasing the optical power by the amplification factor. In our preliminary work (FIG. 3e), we show that this increase in SNR holds in the presence of electronic noise from the detector and when limited by shot noise. We continue to explore whether other noise sources such as laser RIN, phase noise, thermomechanical, and thermoconductive noise limit this improvement. An IWVA interferometer with an optical fiber as the sensing arm can be used to characterize thermomechanical and thermoconductive noise. Thermomechanical and thermoconductive noise scale linearly with fiber length [62] and we can increase their contribution by using a longer length of fiber. Different regions of the spectrum can be viewed to distinguish between thermomechanical and thermoconductive noise. Thermomechanical noise in fibers dominates at low frequencies (<−100 Hz) while thermoconductive dominates at higher frequencies (>−1 kHz) [62]. The laser can be stabilized with an external cavity housed in a vacuum chamber to reach this sensitivity. Thermal noise has a 1/f characteristic at low frequencies and IWVA has been shown to suppress 1/f noise [55]. Thermal noise at low and high frequencies can be characterized and compared a standard interferometer with its IWVA counterpart. Suppressing thermal noise at low frequencies is a significant achievement for high sensitivity measurements in the search for scalar and vector dark matter [63, 64].

### Applications of On-Chip Weak Value Amplification

On-chip weak value amplification devices can address two important challenges in metrology: high sensitivity optical readout for cavity-based measurements and laser frequency measurements and stabilization. The weak value amplified optical readout can have a transformative impact and provide a range of measurements from high accuracy displacement sensors to dark matter detection. The weak value amplified laser frequency measurement and stabilization can provide low noise laser locking with a chip scale device.

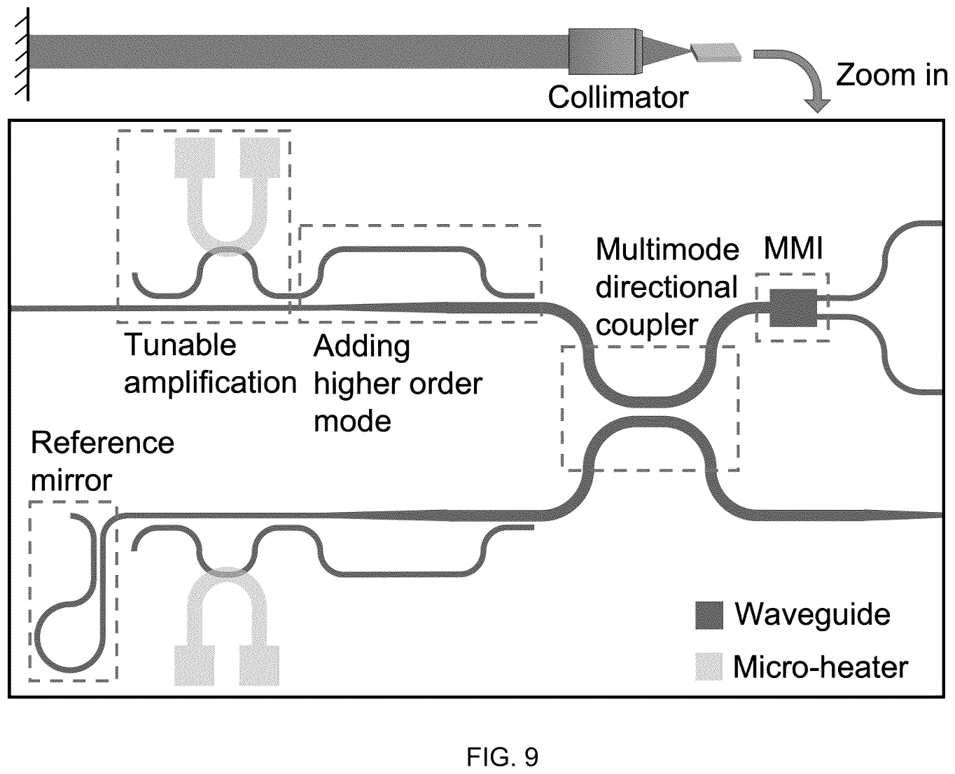

FIG. 9 is drawing showing a schematic diagram of a weak value amplified optical readout. Light from the IWVA chip is collimated as it exits the chip and is sent to the transducer for optical readout (a mirror in this example). The IWVA chip can include components to maximize SNR enhancement and includes a reference arm. The IWVA chip can replace a standard interferometer and increase the sensitivity of the measurement without having to change anything about the experiment. The mirror can be mounted on a piezo stage and set to oscillate with a varying amplitude. The coupling and reflectivity of the reference mirror can be adjusted to account for the insertion loss of the light leaving and returning to the chip. The results can be compared for a standard interferometer and an IWVA interferometer.

As shown in FIG. 9, the reference arm of the weak value amplified MZI stays on the chip. A modified weak value amplified Mach-Zehnder interferometer (MZI) where the phase sensing arm couples out of the chip to a transducer can be used as a weak value amplified optical readout.

However, the weak value readout is a three-port device (one input and two outputs) while our IWVA MZI has two input ports (only one is used) and three output ports (only two are used). A circulator on the input port, which also serves as the bright port of the interferometer, can be used to avoid forming standing waves and destabilizing the laser. The light from the bright port can be recycled to enhance the weak value process [65] used for laser cavity stabilization, or as a light source since it has very little information that can be easily filtered out because it lies in the TE₁ mode (opposite of the dark port where the information is in the TE₀ mode) [66]. A difference between the fully on-chip weak value amplification and the weak value amplification readout lies in using an off-chip phase transducer. An off-chip phase transducer can be used to apply a weak value amplification to enhance sensing for applications that use an optical readout. An IWVA optical readout can be used as a displacement sensor. High accuracy positioning is important in the semiconductor industry where there is a need to constantly improve the alignment and placement of lithographically defined features as they get closer to single nanometer features.

More generally, any suitable mode sensitive coupler with a mode sensitive coupler input port and at least one mode sensitive coupler output port (typically two or more), can be used in place of the multimode directional coupler shown in FIG. 9. A Y-junction device can also be used in place of the MMI shown in FIG. 9.

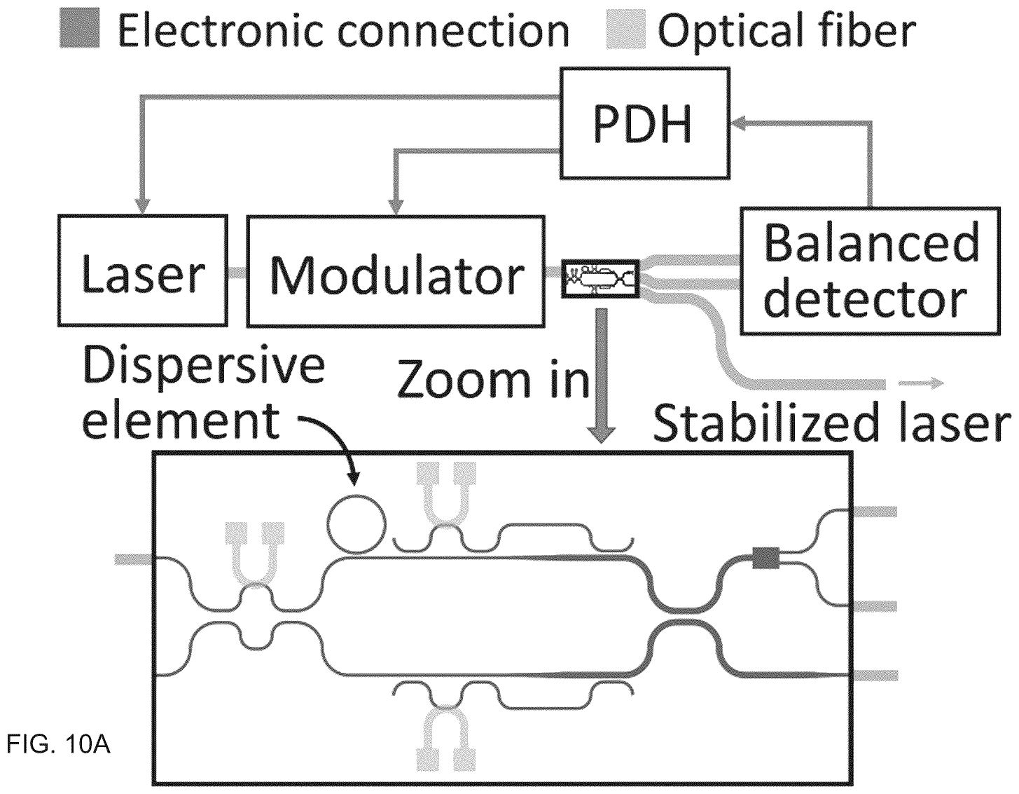

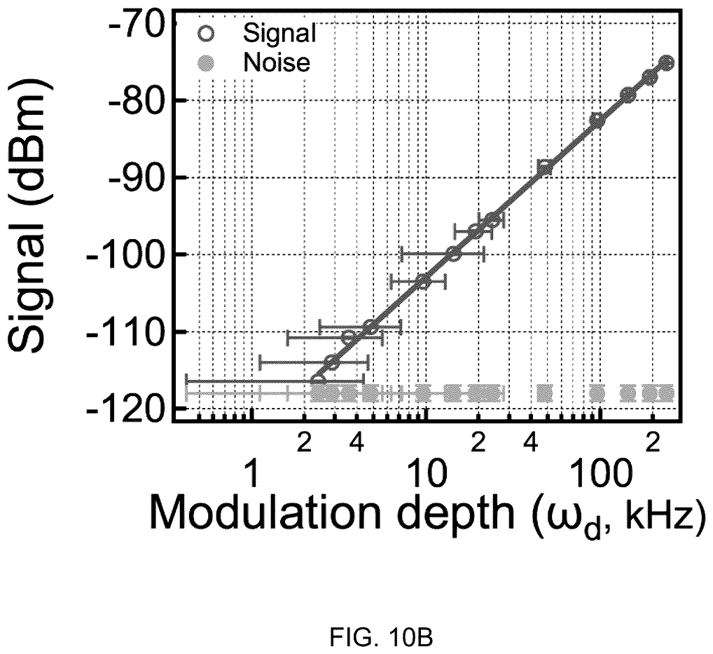

FIG. 10A is a drawing showing a schematic diagram of an exemplary WVA laser stabilization device where the dispersive element (ring resonator) converts laser frequency changes into phase. The balanced detector receives optical output of the IWVA device and is electrically coupled to the Pound-Drever-Hall technique block (PDH). The PDH block is electrically coupled to the laser and the modulator. The IWVA enhances the signal and provides higher stability laser locking. The stabilized laser output is the IWVA bright port. FIG. 10B is a graph showing frequency measurement using the IWVA MZI with ring resonator of FIG. 10A. A dispersive element can be added to the sensing arm of the IWVA MZI for frequency measurements. Adding a ring resonator to the sensing arm of the MZI converts changes in frequency to changes in phase that can be read out with the interferometer.

Other dispersive, such as Bragg grating cavities and photonic crystal cavities can be used. The ring resonator cavity can reach very high quality factors in a compact area (>50×10⁶) [43]. Our preliminary results (FIG. 10B) using a ring resonator to measure laser frequency with on-chip WVA [11] show better performance than bulk optics IWVA demonstrations (sensitivity of ˜6.2 kHz/Hz^{1/2} for on-chip vs 129 kHz/Hz^{1/2} for bulk optics) [8].

Frequency measurements can be extended to higher sensitivity by increasing the cavity quality factor and by coupling the ring resonator cavity to the devices. Enhanced sensitivity can be used to stabilize a laser using the cavity coupled, on-chip IWVA device. The resonator coupling can be optimized to maximize the cavity signal [18]. The laser can be input into an on-chip IWVA device. A small part of the laser power can end up in the dark port due to the weak value amplification. This signal can be used to feed back to the laser. The bright port is the stabilized laser output. The bright port of the on-chip IWVA device includes mostly TE₀ light and the information from the interferometer is in the small fraction of TE₁ light present. This fraction is the same amount as the inverse of the amplification factor. To make the output purely TE₀, the bright port output waveguide can be tapered so that it only supports the TE₀ mode and the TE₁ mode radiates away [66].

The IWVA readout device can likely be used for the detection of ultralight dark matter. Ultralight dark matter behaves as a wave, a classical coherent field, due to its low mass (m_{DM}˜<10¹ eV/c²). Scalar DM fields modulate the size of atoms and would manifest as a mechanical strain that can be observed with optomechanical vibrating devices [63]. On the other hand, if dark matter is a vector field, it would produce a material dependent force that acts on everything and gradients of this force could be detected with an optomechanical experiment [64]. Noise calculations and determine the feasibility of detecting these types of UDM. An optomechanical oscillator can be used with the IWVA optical readout.

Device and simulations . . . A computer readable non-transitory storage medium as non-transitory data storage includes any data stored on any suitable media in a non-fleeting manner. Such data storage includes any suitable computer readable non-transitory storage medium, including, but not limited to hard drives, non-volatile RAM, SSD devices, CDs, DVDs, etc.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

### REFERENCES FOR PART 1

1. G. T. Reed, G. Mashanovich, F. Y. Gardes, and D. J. Thomson, “Silicon optical modulators,” Nature Photon 4, 518-526 (2010).
2. Y. Aharonov, D. Z. Albert, and L. Vaidman, “How the result of a measurement of a component of the spin of a spin-½ particle can turn out to be 100,” Phys. Rev. Lett. 60, 1351-1354 (1988).
3. O. Hosten and P. Kwiat, “Observation of the Spin Hall Effect of Light via Weak Measurements,” Science 319, 787-790 (2008).
4. P. B. Dixon, D. J. Starling, A. N. Jordan, and J. C. Howell, “Ultrasensitive Beam Deflection Measurement via Interferometric Weak Value Amplification,” Phys. Rev. Lett. 102, 173601 (2009).
5. J. Harris, R. W. Boyd, and J. S. Lundeen, “Weak Value Amplification Can Outperform Conventional Measurement in the Presence of Detector Saturation,” Phys. Rev. Lett. 118, 070802 (2017).
6. A. N. Jordan, J. Martinez-Rincón, and J. C. Howell, “Technical Advantages for Weak-Value Amplification: When Less Is More,” Phys. Rev. X 4, 011031 (2014).
7. I. M. Duck, P. M. Stevenson, and E. C. G. Sudarshan, “The sense in which a “weak measurement” of a spin-½ particle's spin component yields a value 100,” Phys. Rev. D 40, 2112-2117 (1989).
8. J. Dressel, M. Malik, F. M. Miatto, A. N. Jordan, and R. W. Boyd, “Colloquium: Understanding quantum weak values: Basics and applications,” Rev. Mod. Phys. 86, 307-316 (2014).
9. J. C. Howell, D. J. Starling, P. B. Dixon, P. K. Vudyasetu, and A. N. Jordan, “Interferometric weak value deflections: Quantum and classical treatments,” Phys. Rev. A 81, 033813 (2010).
10. M. Song, J. Steinmetz, Y. Zhang, J. Nauriyal, K. Lyons, A. N. Jordan, and J. Cardenas, “Enhanced on-chip phase measurement by inverse weak value amplification,” Nat Commun 12, 6247 (2021).
11. J. Steinmetz, J. Steinmetz, K. Lyons, K. Lyons, M. Song, J. Cardenas, A. N. Jordan, A. N. Jordan, A. N. Jordan, and A. N. Jordan, “Enhanced on-chip frequency measurement using weak value amplification,” Opt. Express, OE 30, 3700-3718 (2022).
12. C. Krafczyk, A. N. Jordan, M. E. Goggin, and P. G. Kwiat, “Enhanced Weak-Value Amplification via Photon Recycling,” Phys. Rev. Lett. 126, 220801 (2021).

### REFERENCES FOR PART 2

1. Abbott B P, et al. (2009) LIGO: the Laser Interferometer Gravitational-Wave Observatory. Reports on Progress in Physics, 72(7):076901. https://doi.org/10.1088/0034-4885/72/7/076901
2. Abbott B P, et al. (2017) GW170104: Observation of a 50-Solar-Mass Binary Black Hole Coalescence at Redshift 0.2. Physical Review Letters, 118(22):221101. https://doi.org/10.1103/PhysRevLett.118.221101
3. Bergh R A, Lefevre H C, Shaw H J (1981) All-single-mode fiber-optic gyroscope with long-term stability. Optics Letters, 6(10):502-504. https://doi.org/10.1364/O L.6.000502
4. Liang W, Ilchenko V S, Savchenkov A A, Dale E, Eliyahu D, Matsko A B, Maleki L (2017) Resonant microphotonic gyroscope. Optica, 4(1):114-117. https://doi.org/10.1364/OPTICA.4.000114
5. Li J, Suh M-G, Vahala K (2017) Microresonator Brillouin gyroscope. Optica, 4(3):346-348. https://doi.org/10.1364/OPTICA.4.000346
6. Aharonov Y, Albert D Z, Vaidman L (1988) How the result of a measurement of a component of the spin of a spin-½ particle can turn out to be 100. Physical Review Letters, 60(14):1351-1354. https://doi.org/10.1103/PhysRevLett.60.1351
7. Hosten 0, Kwiat P (2008) Observation of the Spin Hall Effect of Light via Weak Measurements. Science, 319(5864):787-790. https://doi.org/10.1126/science.1152697
8. Dixon P B, Starling D J, Jordan A N, Howell J C (2009) Ultrasensitive Beam Deflection Measurement via Interferometric Weak Value Amplification. Physical Review Letters, 102(17):173601. https://doi.org/10.1103/PhysRevLett.102.173601
9. Harris J, Boyd R W, Lundeen J S (2017) Weak Value Amplification Can Outperform Conventional Measurement in the Presence of Detector Saturation. Physical Review Letters, 118(7):070802. https://doi.org/10.1103/PhysRevLett.118.070802
10. Jordan A N, Martfnez-Rincón J, Howell J C (2014) Technical Advantages for Weak-Value Amplification: When Less Is More. Physical Review X, 4(1):011031. https://doi.org/10.1103/PhysRevX.4.011031
11. Song M, Steinmetz J, Zhang Y, Nauriyal J, Lyons K, Jordan A N, Cardenas J (2021) Enhanced on-chip phase measurement by inverse weak value amplification. Nature Communications, 12(1):6247. https://doi.org/10.1038/s41467-021-26522-2
12. Steinmetz J, Steinmetz J, Lyons K, Lyons K, Song M, Cardenas J, Jordan A N, Jordan A N, Jordan A N, Jordan A N (2022) Enhanced on-chip frequency measurement using weak value amplification. Optics Express, 30(3):3700-3718. https://doi.org/10.1364/O E.444216
13. Cardenas J, Foster M A, Sherwood-Droz N, Poitras C B, Lira H L R, Zhang B, Gaeta A L, Khurgin J B, Morton P, Lipson M (2010) Wide-bandwidth continuously tunable optical delay line using silicon microring resonators. Optics Express, 18(25):26525-26534. https://doi.org/10.1364/OE.18.026525
14. Cardenas J, Poitras C B, Luke K, Luo L-W, Morton P A, Lipson M (2014) High Coupling Efficiency Etched Facet Tapers in Silicon Waveguides. IEEE Photonics Technology Letters, 26(23):2380-2382. https://doi.org/10.1109/LPT.2014.2357177
15. Cardenas J, Luke K, Luo L W, Poitras C B, Morton P A, Lipson M, Lipson M (2012) High Coupling Efficiency Etched Facet Tapers in Silicon. Conference on Lasers and Electro-Optics 2012 (2012), paper JW4A.10, JW4A.10. https://doi.org/10.1364/CLEO_AT.2012.JW4A.10
16. Cardenas J, Manipatruni S, Sherwood-Droz N, Poitras C B, Zhang B, Khurgin J B, Morton P A, Lipson M (2010) Large Tunable Delay of an R F Photonic Signal with 130 GHz Bandwidth Using Silicon Microresonators. Conference on Lasers and Electro-Optics 2010 (2010), paper CWG3, CWG3. https://doi.org/10.1364/CLEO.2010.CWG3
17. Cardenas J, Morton P A, Khurgin J B, Poitras C B, Lipson M, Lipson M (2012) Super-Ring Resonators: Taking Advantage of Resonance Variability. Conference on Lasers and Electro-Optics 2012 (2012), paper CTu3I.4, CTu3I.4. https://doi.org/10.1364/CLEO_SI.2012.CTu3I.4
18. Cardenas J, Morton P A, Khurgin J B, Griffith A, Poitras C B, Preston K, Lipson M (2013) Linearized silicon modulator based on a ring assisted Mach Zehnder inteferometer. Optics Express, 21(19):22549. https://doi.org/10.1364/OE.21.022549
19. Cardenas J, Poitras C B, Robinson J T, Preston K, Chen L, Lipson M (2009) Low loss etchless silicon photonic waveguides. Optics Express, 17(6):4752-4757. https://doi.org/10.1364/O E.17.004752
20. Cardenas J, Sherwood N, Foster M A, Poitras C B, Gaeta A L, Lipson M, Khurgin J B, Morton P A (2009) Large bandwidth continuously tunable delay using silicon microring resonators. 2009 6th IEEE International Conference on Group I V Photonics, 37-39. https://doi.org/10.1109/GROUP4.2009.5338296
21. Dutt A, Miller S, Luke K, Cardenas J, Gaeta A L, Nussenzveig P, Lipson M (2016) Tunable squeezing using coupled ring resonators on a silicon nitride chip. Optics Letters, 41(2):223-226. https://doi.org/10.1364/O L.41.000223
22. Fain R, Fain R, Miller S A, Miller S A, Yu M, Griffith A G, Cardenas J, Lipson M, Lipson M (2017) CMOS-compatible Mid-Infrared Silicon Detector. Conference on Lasers and Electro-Optics (2017), paper STu1N.4, STu1N.4. https://doi.org/10.1364/CLEO_SI.2017.STu1N.4
23. Griffith A, Cardenas J, Poitras C B, Lipson M (2012) High quality factor and high confinement silicon resonators using etchless process. Optics Express, 20(19):21341-21345. https://doi.org/10.1364/OE.20.021341
24. Guha B, Preston K, Lipson M (2012) Athermal silicon microring electro-optic modulator. Optics Letters, 37(12):2253-2255. https://doi.org/10.1364/OL.37.002253
25. Lee Y H D, Cardenas J, Lipson M, Lipson M (2015) Linear silicon PN junction phase modulator. CLEO: 2015 (2015), paper SW3N.5, SW3N.5. https://doi.org/10.1364/CLEO_SI.2015.SW3N.5
26. Lira H L R, Cardenas J, Lipson M (2010) High performance add-drop filter tunable over large spectral range. 2010 Conference on Lasers and Electro-Optics (CLEO) and Quantum Electronics and Laser Science Conference (QELS), 1-2.
27. Luo L-W, Ibrahim S, Poitras C B, Djordjevic S S, Lira H L R, Zhou L, Cardenas J, Guan B, Nitkowski A, Ding Z, Yoo S J B, Lipson M (2010) Fully Reconfigurable Silicon Photonic Interleaver. Conference on Lasers and Electro-Optics 2010 (2010), paper CFL5, CFL5. https://doi.org/10.1364/CLEO.2010.CFL5
28. Luo L-W, Wiederhecker G S, Cardenas J, Poitras C, Lipson M (2011) High quality factor etchless silicon photonic ring resonators. Optics Express, 19(7):6284-6289. https://doi.org/10.1364/OE.19.006284
29. Miller S A, Yu M, Ji X, Griffith A G, Cardenas J, Gaeta A L, Lipson M (2017) Low-loss silicon platform for broadband mid-infrared photonics. Optica, 4(7):707-712. https://doi.org/10.1364/OPTICA.4.000707
30. Morton P A, Cardenas J, Khurgin J B, Lipson M (2011) Fast thermal switching of wideband optical delay line with no long-term transient. IEEE Photonics Technology Letters, 24(6):512-514.
31. Morton P A, Cardenas J, Lipson M, Khurgin J B (2013) Miniature, Linearized silicon photonics modulators for phased array systems. 2013 IEEE International Topical Meeting on Microwave Photonics (MWP), 275-277. https://doi.org/10.1109/MWP.2013.6724074
32. Nauriyal J, Song M, Granados-Baez M, Zhang Y, Cardenas J (2020) Single-shot, Multiple I/O Photonic Chip to Fiber Array Packaging Using Fusion Splicing. Conference on Lasers and Electro-Optics (2020), paper JTh2B.9, JTh2B.9. https://doi.org/10.1364/CLEO_AT.2020.JTh2B.9
33. Nauriyal J, Song M, Yu R, Cardenas J (2019) Fiber-to-chip fusion splicing for low-loss photonic packaging. Optica, 6(5):549-552. https://doi.org/10.1364/OPTICA.6.000549
34. Phare C T, Daniel Lee Y-H, Cardenas J, Lipson M (2015) Graphene electro-optic modulator with 30 GHz bandwidth. Nature Photonics, 9(8):511-514. https://doi.org/10.1038/nphoton.2015.122
35. Roberts S P, Ji X, Cardenas J, Bryant A, Lipson M (2017) Sidewall roughness in Si3N4 waveguides directly measured by atomic force microscopy. 2017 Conference on Lasers and Electro-Optics (CLEO), 1-2.
36. Phare C T, Phare C T, Cardenas J, Lee Y H D, Lipson M (2016) Linear Graphene on Silicon Nitride Electroabsorption Modulators for RF-Over-Fiber Links. Conference on Lasers and Electro-Optics (2016), paper SF2G.2, SF2G.2. https://doi.org/10.1364/CLEO_SI.2016.SF2G.2
37. Stern B, Zhu X, Chen C P, Tzuang L D, Cardenas J, Bergman K, Lipson M, Lipson M (2015) Integrated Switch for Mode-Division Multiplexing (MDM) and Wavelength-Division Multiplexing (WDM). CLEO: 2015 (2015), paper STh1F.2, STh1F.2. https://doi.org/10.1364/CLEO_SI.2015.STh1F.2
38. Stem B, Zhu X, Chen C P, Tzuang L D, Cardenas J, Bergman K, Lipson M (2015) On-chip mode-division multiplexing switch. Optica, 2(6):530-535. https://doi.org/10.1364/OPTICA.2.000530
39. Dutt A, Cardenas J, Okawachi Y, Joshi C, Ji X, Luke K, Gaeta A L, Lipson M (2016) Generation of dual frequency combs using cascaded microring resonators. 2016 Conference on Lasers and Electro-Optics (CLEO), 1-2.
40. Dutt A, Joshi C, Ji X, Cardenas J, Okawachi Y, Luke K, Gaeta A L, Lipson M (2018) On-chip dual-comb source for spectroscopy. Science Advances, 4(3):e1701858. https://doi.org/10.1126/sciadv.1701858
41. Griffith A G, Lau R K W, Cardenas J, Okawachi Y, Mohanty A, Fain R, Lee Y H D, Yu M, Phare C T, Poitras C B, Gaeta A L, Lipson M (2015) Silicon-chip mid-infrared frequency comb generation. Nat Commun, 6http://dx.doi.org/10.1038/ncomms7299
42. Griffith A G, Yu M, Okawachi Y, Cardenas J, Mohanty A, Gaeta A L, Lipson M (2016) Coherent mid-infrared frequency combs in silicon-microresonators in the presence of Raman effects. Optics Express, 24(12):13044-13050. https://doi.org/10.1364/OE.24.013044
43. Ji X, Barbosa F A S, Roberts S P, Dutt A, Cardenas J, Okawachi Y, Bryant A, Gaeta A L, Lipson M (2017) Ultra-low-loss on-chip resonators with sub-milliwatt parametric oscillation threshold. Optica, 4(6):619-624. https://doi.org/10.1364/OPTICA.4.000619
44. Johnson A R, Okawachi Y, Levy J S, Cardenas J, Saha K, Lipson M, Gaeta A L (2012) Chip-based frequency combs with sub-100 GHz repetition rates. Optics Letters, 37(5):875-877. https://doi.org/10.1364/OL.37.000875
45. Okawachi Y, Yu M, Cardenas J, Ji X, Lipson M, Gaeta A L (2017) Coherent, directional supercontinuum generation. Optics Letters, 42(21):4466-4469.
46. Okawachi Y, Yu M, Cardenas J, Ji X, Klenner A, Lipson M, Gaeta A L (2018) Carrier envelope offset detection via simultaneous supercontinuum and second-harmonic generation in a silicon nitride waveguide. Optics Letters, 43(19):4627-4630. https://doi.org/10.1364/O L.43.004627
47. Gabrielli L H, Cardenas J, Poitras C B, Lipson M (2009) Silicon nanostructure cloak operating at optical frequencies. Nature Photonics, 3(8):461-463. https://doi.org/10.1038/nphoton.2009.117
48. Gabrielli L H, Cardenas J, Poitras C B, Lipson M (2009) Demonstration of cloaking at optical frequencies. 2009 Conference on Lasers and Electro-Optics and 2009 Conference on Quantum electronics and Laser Science Conference, 1-2. https://doi.org/10.1364/IQEC.2009.IPDB3
49. He X, Cardenas J (2022) Fully integrated on-chip ring resonator spectrometer based on compressed sensing. Conference on Lasers and Electro-Optics (2022), paper SM4L.2, SM4L.2.
50. Mohanty A, Li Q, Tadayon M A, Roberts S P, Bhatt G R, Shim E, Ji X, Cardenas J, Miller S A, Kepecs A, Lipson M (2020) Reconfigurable nanophotonic silicon probes for sub-millisecond deep-brain optical stimulation. Nature Biomedical Engineering, 4(2):223-231. https://doi.org/10.1038/s41551-020-0516-y
51. Mohanty A, Mohanty A, Li Q, Tadayon M A, Bhatt G R, Shim E, Ji X, Ji X, Cardenas J, Cardenas J, Miller S A, Kepecs A, Lipson M (2018) An Active Visible Nanophotonics Platform for Sub-Millisecond Deep Brain Neural Stimulation. Conference on Lasers and Electro-Optics (2018), paper ATh3Q.1, ATh3Q.1. https://doi.org/10.1364/CLEO_AT.2018.ATh3Q.1
52. Fain R, Barbosa F, Cardenas J, Lipson M (2017) Photonic Needles for Light Delivery in Deep Tissue-like Media. Scientific Reports, 7(1):5627. https://doi.org/10.1038/s41598-017-05746-7
53. Fain R, Wang T, Wang M, Charan K, Barbosa F A S, Cardenas J, Xu C, Lipson M (2016) Ultra Small Cross-Section Photonic Probes for Deep Tissue Non-Invasive Light Delivery. Conference on Lasers and Electro-Optics (2016), paper JW2A.141, JW2A.141. https://doi.org/10.1364/CLEO_AT.2016.JW2A.141
54. Duck I M, Stevenson P M, Sudarshan E C G (1989) The sense in which a “weak measurement” of a spin-½ particle's spin component yields a value 100. Physical Review D, 40(6):2112-2117. https://doi.org/10.1103/PhysRevD.40.2112
55. Dressel J, Malik M, Miatto F M, Jordan A N, Boyd R W (2014) Colloquium: Understanding quantum weak values: Basics and applications. Reviews of Modern Physics, 86(1):307-316. https://doi.org/10.1103/RevModPhys.86.307
56. Howell J C, Starling D J, Dixon P B, Vudyasetu P K, Jordan A N (2010) Interferometric weak value deflections: Quantum and classical treatments. Physical Review A, 81(3):033813. https://doi.org/10.1103/PhysRevA.81.033813
57. Viza G I, Martinez-Rincón J, Howland G A, Frostig H, Shomroni I, Dayan B, Howell J C (2013) Weak-values technique for velocity measurements. Optics Letters, 38(16):2949-2952. https://doi.org/10.1364/O L.38.002949
58. Dutt A, Luke K, Manipatruni S, Gaeta A L, Nussenzveig P, Lipson M (2015) On-Chip Optical Squeezing. Physical Review Applied, 3(4):044005. https://doi.org/10.1103/PhysRevApplied.3.044005
59. Zhang Y, Menotti M, Tan K, Vaidya V D, Mahler D H, Helt L G, Zatti L, Liscidini M, Morrison B, Vernon Z (2021) Squeezed light from a nanophotonic molecule. Nature Communications, 12(1):2233. https://doi.org/10.1038/s41467-021-22540-2
60. Vahlbruch H, Mehmet M, Danzmann K, Schnabel R (2016) Detection of 15 dB Squeezed States of Light and their Application for the Absolute Calibration of Photoelectric Quantum Efficiency. Physical Review Letters, 117(11):110801. https://doi.org/10.1103/PhysRevLett.117.110801
61. Diels J-C M, Horstman L (2022) Increasing signal to noise by enhancing sensitivity and decreasing noise. Optical and Quantum Sensing and Precision Metrology II, PC12016:PC120162N. https://doi.org/10.1117/12.2623286
62. Duan L (2012) General treatment of the thermal noises in optical fibers. Physical Review A, 86(2):023817. https://doi.org/10.1103/PhysRevA.86.023817
63. Manley J, Wilson D J, Stump R, Grin D, Singh S (2020) Searching for Scalar Dark Matter with Compact Mechanical Resonators. Physical Review Letters, 124(15):151301. https://doi.org/10.1103/PhysRevLett.124.151301
64. Manley J, Chowdhury M D, Grin D, Singh S, Wilson D J (2021) Searching for Vector Dark Matter with an Optomechanical Accelerometer. Physical Review Letters, 126(6):061301. https://doi.org/10.1103/PhysRevLett.126.061301
65. Krafczyk C, Jordan A N, Goggin M E, Kwiat P G (2021) Enhanced Weak-Value Amplification via Photon Recycling. Physical Review Letters, 126(22):220801. https://doi.org/10.1103/PhysRevLett.126.220801
66. Meiting Song, Juniyali Nauriyal, John Steinmetz, Sinabu Pumulo, Nicholas Achuthan, Kevin Lyons, Andrew N. Jordan, Jaime Cardenas (2022) Integrated optical gyroscope with inverse weak value amplification.
67. Gasiewski J, Herrera F A, Mosqueda C M, Hurtado S, Chang M (2011) The pathway to loneliness: When institutional support really matters for STEM graduate students. Association for Institutional Research Annual Forum,
68. Empowering Diversity Leaders: Proceedings of the 2017 Alliances for Graduate Education and the Professoriate National Forum I Council of Graduate Schools. https://cgsnet.org/empowering-diversity-leaders-proceedings-2017-alliances-graduate-education-and-professoriate
69. Ali A, Kohun F (2007) Dealing with Social Isolation to Minimize Doctoral Attrition-A Four Stage Framework. International Journal of Doctoral Studies, 2:33.
70. Lipscomb R, An S (2010) Mentoring 101: Building a mentoring relationship. Journal of the American Dietetic Association, 110(7):1008.
71. Beier M E, Kim M H, Saterbak A, Leautaud V, Bishnoi S, Gilberto J M (2019) The effect of authentic project-based learning on attitudes and career aspirations in STEM. Journal of Research in Science Teaching, 56(1):3-23. https://doi.org/10.1002/tea.21465
72. Moraros J, Islam A, Yu S, Banow R, Schindelka B (2015) Flipping for success: evaluating the effectiveness of a novel teaching approach in a graduate level setting. BMC Medical Education, 15(1):27. https://doi.org/10.1186/s12909-015-0317-2
73. He X, Luis Cortes-Herrera, Kwadwo Opong-Mensah, Yi Zhang, Meiting Song, Govind Agrawal, Jaime Cardenas (2022) Electricall induced adiabatic wavelength conversion in an integrated lithium niobate ring resonator. Conference on Lasers and Electro-Optics (2022), paper SM40.4, SM4O.4.
74. Cortes-Herrera L, He X, Cardenas J, Agrawal G P (2021) Coupled-mode theory of the polarization dynamics inside a microring resonator with a uniaxial core. Physical Review A, 103(6):1-14. https://doi.org/10.1103/PhysRevA.103.063517
75. Cortes-Herrera L, He X, Cardenas J, Agrawal G P (2021) Design of an X-cut thin-film lithium niobate waveguide as a passive polarization rotator. Optics Express, 29(26):44174. https://doi.org/10.1364/oe.445412.

What is claimed is:

1. An inverse weak value amplification device for optical amplitude modulation comprising:
a Mach-Zehnder interferometer (MZI) having an MZI input port and an MZI output port, said MZI comprising a first arm and a second arm;
a controlled phase shifter having a modulation input port and a phase shifter optical output, said controlled phase shifter disposed in said first arm;
a first mode coupler optically coupled to said phase shifter optical output of said controlled phase shifter in said first arm; and
a second mode coupler disposed in said second arm.

2. The inverse weak value amplification device of claim 1, further comprising an additional controlled phase shifter optically coupled to and preceding said second mode coupler in said second arm.

3. The inverse weak value amplification device of claim 1, wherein said controlled phase shifter comprises a voltage controlled phase shifter.

4. The inverse weak value amplification device of claim 3, wherein said voltage controlled phase shifter comprises integrated electrodes.

5. The inverse weak value amplification device of claim 1, further comprising an erbium-doped fiber amplifier (EDFA) optically coupled to said MZI output port to provide an amplified modulated light.

6. The inverse weak value amplification device of claim 1, further comprising a semiconductor optical amplifier (SOA) optically coupled to said MZI output port to provide an amplified modulated light.

7. The inverse weak value amplification device of claim 1, further comprising an additional MZI output port to provide a recycle light.

8. The inverse weak value amplification device of claim 1, wherein said inverse weak value amplification device comprises an integrated inverse weak value amplification device with planar waveguides.

9. The inverse weak value amplification device of claim 8, wherein said integrated inverse weak value amplification device with a plurality of planar waveguides comprises a length in a longitudinal direction of said first arm of less than about 100 μm.

10. The inverse weak value amplification device of claim 8, wherein said integrated inverse weak value amplification device with a plurality of planar waveguides comprises a length in a longitudinal direction of said first arm of less than about 2.5 mm.

11. An inverse weak value amplification device for ultra-high amplification comprising:
a Mach-Zehnder interferometer (MZI) having an MZI input port and an MZI output port, said MZI comprising a first arm and a second arm;
a wavefront tilter disposed in said first arm comprising a mode coupler; and
a tunable amplification section disposed in said wavefront tilter preceding and optically coupled to said mode coupler.

12. The inverse weak value amplification device of claim 11, further comprising a voltage controlled micro heater thermally coupled to said tunable amplification section.

13. The inverse weak value amplification device of claim 11, further comprising a carrier injection or carrier depletion voltage control of said tunable amplification.

14. The inverse weak value amplification device of claim 11, further comprising an electro-optic effect voltage control of said tunable amplification.

15. The inverse weak value amplification device of claim 11, further comprising a multimode directional coupler optically coupled to said MZI output port.

16. An inverse weak value amplification device for optical readout of a sensor comprising:
a Mach-Zehnder interferometer (MZI) having an MZI input port and an MZI output port, said MZI comprising a first arm and a second arm;
a first wavefront tilter disposed in said first arm comprising a first mode coupler;
a first tunable amplification section disposed in said first wavefront tilter preceding and optically coupled to a first mode coupler;
a second wavefront tilter disposed in said second arm comprising a second mode coupler;
a second tunable amplification section disposed in said second wavefront tilter preceding and optically coupled to said second mode coupler; and
a mode sensitive coupler comprising a mode sensitive coupler input port and at least one mode sensitive coupler output port, and
wherein a reference mirror is optically coupled said second arm, and a sensor optical signal is optically coupled to said first arm and said at least one mode sensitive coupler output port provides said optical readout.

17. The inverse weak value amplification device for inverse weak value amplification device for optical readout of a sensor of claim 16, wherein said mode sensitive coupler comprises a multimode directional coupler.

18. The inverse weak value amplification device for inverse weak value amplification device for optical readout of a sensor of claim 16, wherein said mode sensitive coupler comprises a Y-junction device.

19. The inverse weak value amplification device for inverse weak value amplification device for optical readout of a sensor of claim 16, further comprising a voltage controlled micro heater thermally coupled to at least one of said first tunable amplification section or said second tunable amplification section.

20. The inverse weak value amplification device for optical readout of a sensor of claim 16, further comprising a carrier injection or carrier depletion voltage control of at least one of said first tunable amplification section or said second tunable amplification section.

21. The inverse weak value amplification device for optical readout of a sensor of claim 16, further comprising an electro-optic effect voltage control of at least one of said first tunable amplification section or said second tunable amplification section.

22. A laser stabilization inverse weak value amplification device comprising:
a Mach-Zehnder interferometer (MZI) having an MZI input port and an MZI output port, said MZI comprising a first arm and a second arm;
a dispersive element disposed in said first arm followed by a first wavefront tilter disposed in said first arm comprising a first mode coupler;
a first tunable amplification section disposed in said first wavefront tilter preceding and optically coupled to said first mode coupler;
a second wavefront tilter disposed in said second arm comprising a second mode coupler;
a second tunable amplification section disposed in said second wavefront tilter preceding and optically coupled to said second mode coupler; and
a multimode directional coupler comprising a first input port optically coupled to an optical output of said first wavefront tilter, a second input port optically coupled to a second wavefront tilter optical output, an output port.

23. A laser stabilization system including the laser stabilization inverse weak value amplification device of claim 22 comprising:
a laser;
a modulator optically coupled to laser;
said laser stabilization inverse weak value amplification device optically coupled to said modulator;
a balanced detector optically coupled to said laser stabilization inverse weak value amplification device, said balanced detector having a balanced detector optical output; and
a PDH electrically coupled to said balanced detector optical output, said PDH also includes a first PDH output and a second PDH output, and
wherein said laser is electrically coupled to and receives said first PDH output, and said modulator is electrically coupled to and receives said second PDH output.

24. The laser stabilization system of claim 23, wherein said dispersive element comprises a ring resonator.
